(19) United States
(12) Patent Application Publication
(10) Pub. No.: US 2007/0160370 A1
(43) Pub. Date: Jul. 12, 2007

(54) Camera module whose lens and image sensor can be easily positioned relative to each other

(75) Inventors: Kimihiro Kikuchi, Fukushima-ken (JP); Yoshitaka Inoue, Fukushima-ken (JP); Satoshi Wada, Fukushima-ken (JP)

Correspondence Address: BEYER WEAVER LLP, P.O. BOX 70250, OAKLAND, CA, 94612-0250, US

(73) Assignee: ALPS ELECTRIC CO., LTD.

(21) Appl. No.: 11/602,875

(22) Filed: Nov. 20, 2006

(30) Foreign Application Priority Data
Jan. 10, 2006 (JP) 2006-001997

(51) Int. Cl. G03B 17/00

(52) U.S. Cl. 396/529

(57) ABSTRACT

A camera module includes a lens held in a cylindrical holder and an image sensor disposed at a predetermined distance from the lens. The image sensor is disposed on a substrate. The holder integrally has a protrusion that protrudes toward the image sensor and an outer peripheral portion provided outside the protrusion, the lower end of the outer peripheral portion being lower than the lower end of the protrusion. The lower end surface of the protrusion is fixed to the upper surface of the image sensor with an adhesive, and the lower end surface of the outer peripheral portion is fixed to the upper surface of the substrate with an adhesive.

### BACKGROUND OF THE INVENTION

1. Field of the Invention

The present invention relates to a camera module including a lens and an image sensor, and more specifically, it relates to a camera module in which positioning of a holder relative to a substrate is performed using an adhesive.

2. Description of the Related Art

A camera module provided in small electronic devices such as cell-phones at least includes a lens, a lens barrel holding the lens, and an image sensor that converts light collected by the lens into an electric signal. The distance between the lens and the image sensor is important for obtaining an excellent image in the image sensor. Therefore, the mounting position of the lens barrel relative to the main body is adjusted on a camera-module by camera-module basis. The distance between the lens in the lens barrel and the image sensor can be appropriately adjusted by threading the inner peripheral surface of the main body and the outer peripheral surface of the lens barrel and screwing the lens barrel into the main body, as disclosed in U.S. Pat. No. 6,483,101, for example. Since smaller cameras are needed for cell-phones, the place to which components are fixed is small.

Many of known camera modules need the process of adjusting a lens barrel by screwing. Therefore, components need to be threaded. In addition, an increased number of manufacturing processes increases the cost. Moreover, since there is sufficient adhesion space, joins are not divided.

### SUMMARY OF THE INVENTION

The present invention is made in view of the above problems, and an object of the present invention is to provide a small camera module that does not need a mechanism for adjustment and whose lens and image sensor can be easily positioned relative to each other.

In an aspect of the present invention, a camera module includes a lens held in a cylindrical holder and an image sensor disposed at a predetermined distance from the lens. The image sensor is disposed on a substrate. The holder integrally has a protrusion that protrudes toward the image sensor and an outer peripheral portion provided outside the protrusion, the lower end of the outer peripheral portion being lower than the lower end of the protrusion. The lower end surface of the protrusion is fixed to the upper surface of the image sensor with an adhesive, and the lower end surface of the outer peripheral portion is fixed to the upper surface of the substrate with an adhesive.

In another aspect of the present invention, a camera module includes a lens held in a cylindrical lens barrel and an image sensor disposed at a predetermined distance from the lens. The lens barrel is held in a holder disposed on a substrate, the image sensor being disposed on the upper surface of the substrate. The holder integrally has a protrusion that protrudes toward the image sensor and an outer peripheral portion provided outside the protrusion, the lower end of the outer peripheral portion being lower than the lower end of the protrusion. The lower end surface of the protrusion is fixed to the upper surface of the image sensor with an adhesive, and the lower end surface of the outer peripheral portion is fixed to the upper surface of the substrate with an adhesive.

The holder may have a top plate formed integrally therewith just above the image sensor, and the top plate may have an opening that functions as an optical stop.

The outer peripheral surface of the lens may be in contact with and fixed by adhesion to the inner peripheral surface of the holder or the lens barrel.

The camera module according to the present invention integrally has a protrusion that protrudes toward an image sensor and an outer peripheral portion provided outside the protrusion, the lower end of the outer peripheral portion is lower than the lower end of the protrusion. The lower end surface of the protrusion is fixed to the upper surface of the image sensor with an adhesive. The lower end surface of the outer peripheral portion is fixed to the upper surface of the substrate with an adhesive. By controlling the amount of the adhesive between the holder and the image sensor and controlling the pressure applied during the adhesion, the thickness of the adhesive between the holder and the image sensor can be set in advance, and an appropriate distance between the lens and the image sensor can be easily and accurately achieved without adjustment. In addition, by fixing the outer peripheral portion to the substrate with an adhesive, a sufficient fixing strength can be ensured even if the camera is small, and both the cost and the size can be reduced.

Moreover, in the camera module according to the present invention, the holder has a top plate formed integrally therewith just above the image sensor. The top plate has an opening that functions as an optical stop. Therefore, it is not necessary to provide a component that functions as a stop. Since the number of components can be reduced, the cost can be reduced.

Furthermore, in the camera module according to the present invention, the outer peripheral surface of the lens is in contact with and fixed by adhesion to the inner peripheral surface of the holder or the lens barrel. Since the adhesive does not affect the position of the lens in the vertical direction, an accurate positional relationship between the lens and the image sensor can be achieved.

### BRIEF DESCRIPTION OF THE DRAWINGS

FIG. 1 is a perspective view of a camera module according to a first embodiment;

FIG. 2 is a sectional view of the camera module; and

FIG. 3 is a perspective view of a camera module according to a second embodiment.

### DESCRIPTION OF THE PREFERRED EMBODIMENTS

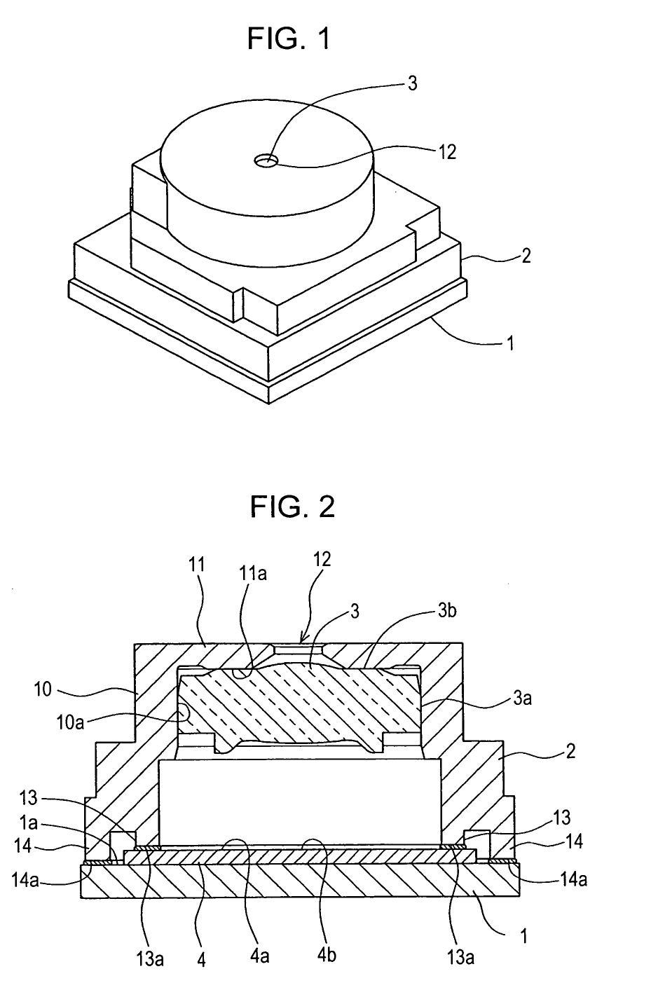

The embodiments of the present invention will now be described with reference to the drawings in detail. FIG. 1 is a perspective view of a camera module manufactured using a method according to a first embodiment. FIG. 2 is a sectional view of the camera module. As shown in FIG. 1, this camera module includes a substrate 1 and a holder 2 disposed thereon. The holder 2 has an integral structure. The holder 2 has an opening 12 formed in the upper surface thereof. The holder 2 holds a lens 3 therein. The lens 3 is coated with a film that functions as a filter to block infrared.

As shown in FIG. 2, an image sensor 4 is disposed on the upper surface 1a of the substrate 1. The image sensor 4 has a light receiving section 4b in the central part thereof. The image sensor 4 has a large number of photoelectric conversion elements arrayed on a plane. The image sensor 4 converts light collected by the lens 3 into image data and outputs the image data. The image sensor 4 is slightly smaller than the substrate 1 and disposed so as not to cover the peripheral part of the upper surface 1a of the substrate 1.

The holder 2 has a lens barrel portion 10 that is generally hollow cylindrical. The lens barrel portion 10 holds the lens 3 therein. The outer peripheral surface 3a of the lens 3 is in contact with and fixed by adhesion to the inner peripheral surface 10a of the lens barrel portion 10.

The lens barrel portion 10 has a top plate 11 provided at the top thereof. The top plate 11 has an opening 12 formed in the center thereof and just above the image sensor 4. Through the opening 12, light from a photographic subject is incident on the lens 3 and the image sensor 4. That is to say, the opening 12 functions as a stop for the lens 3. The outer peripheral surface 3a of the lens 3 is fixed by adhesion to the inner peripheral surface 10a of the lens barrel portion 10, such that the peripheral upper surface 3b of the lens 3 is in contact with the lower surface 11a of the top plate 11. Since an adhesive is provided not on the upper surface but on the outer peripheral surface 3a of the lens 3, the adhesive does not affect the position of the lens 3 in the vertical direction. Therefore, the position of the lens 3 can be set more accurately.

The holder 2 has a protrusion 13 integrally formed on the underside thereof. The protrusion 13 protrudes toward the peripheral part of the image sensor 4, i.e., the part of the image sensor 4 outside the light receiving section 4b. In addition, the holder 2 has an outer peripheral portion 14 integrally formed therewith. The outer peripheral portion 14 lies outside the protrusion 13. The outer peripheral portion 14 protrudes toward the substrate 1. The lower end of the outer peripheral portion 14 is lower than the lower end of the protrusion 13. The lower end surface 13a of the protrusion 13 faces the upper surface 4a of the image sensor 4 with a slight gap therebetween. The lower end surface 14a of the outer peripheral portion 14 faces the upper surface 1a of the substrate 1 with a slight gap therebetween. An adhesive is provided between the lower end surface 13a of the protrusion 13 and the upper surface 4a of the image sensor 4. In addition, an adhesive is provided between the lower end surface 14a of the outer peripheral portion 14 and the upper surface 1a of the substrate 1. With these adhesives, the holder 2 is fixed to the substrate 1 and the image sensor 4.

The positional relationship between the lens 3 and the image sensor 4 is determined by the thickness of the adhesives that fix the holder 2 to the substrate 1 and the image sensor 4. The fact that the distance between the lens 3 and the image sensor 4 needs to be fixed in the range of tens of micrometers to hundreds of micrometers according to the type of optical system can be predicted in optical design. The thickness of an adhesive depends on the type of adhesive, the amount of adhesive, the pressure applied to the adhesive, and the temperature of the adhesive. Experimental tests were performed on the combination of these factors, and an adhesive-thickness design based on the tests and a manufacturing method based on the design achieved a stable thickness. As for other individual components, component-accuracy correction based on the size data and the optical characteristic data of prototype components and product components achieved assembly without adjustment.

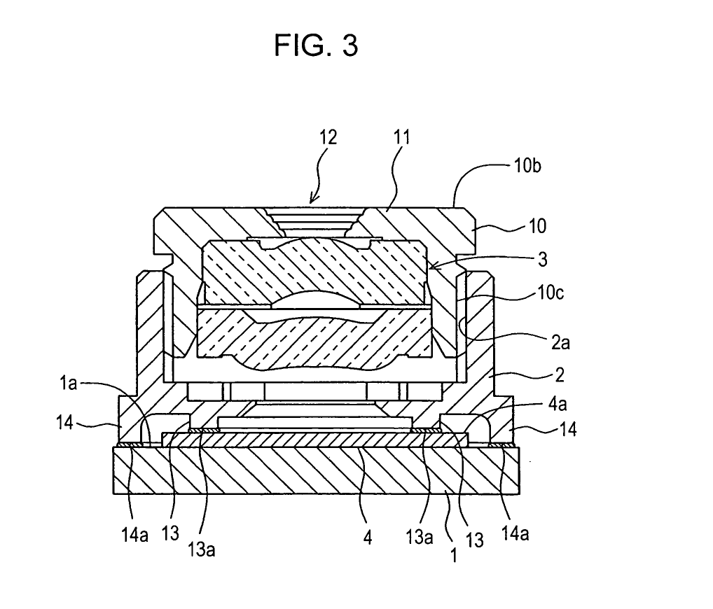

Next, a second embodiment of the present invention will be described. FIG. 3 is a sectional view of a camera module according to this embodiment. In the camera module, a lens barrel 10 that holds a lens 3 therein and a holder 2 are separate components. The upper portion of the holder 2 is hollow cylindrical so as to be able to hold the lens barrel 10 therein. The inner peripheral surface 2a of the holder 2 is provided with a screw thread. The outer peripheral surface 10c of the lens barrel 10 is provided with a screw thread corresponding to the screw thread of the holder 2. The lens barrel 10 has a top plate 11 provided at the top thereof. In addition, the lens barrel 10 has a flange 10b protruding from the outer peripheral surface 10c thereof.

In the second embodiment, the lens barrel 10 can be optically adjusted by being rotated relative to the holder 2. Although the cost of adjustment cannot be reduced, the holder 2 can be stably fixed in aspects of size and strength, in a small camera, with adhesives 13a and 14a provided in the holder 2.

Although embodiments of the present invention have been described above, it is to be understood that the present invention is not intended to be limited to these embodiments, and various changes may be made therein without departing from the scope of the technical idea of the present invention.

What is claimed is:

1. A camera module comprising:
a lens held in a cylindrical holder; and
an image sensor disposed at a predetermined distance from the lens,
wherein the image sensor is disposed on a substrate, the holder integrally has a protrusion that protrudes toward the image sensor and an outer peripheral portion provided outside the protrusion, the lower end of the outer peripheral portion being lower than the lower end of the protrusion,
the lower end surface of the protrusion is fixed to the upper surface of the image sensor with an adhesive, and the lower end surface of the outer peripheral portion is fixed to the upper surface of the substrate with an adhesive.

2. A camera module comprising:
a lens held in a cylindrical lens barrel; and
an image sensor disposed at a predetermined distance from the lens,
wherein the lens barrel is held in a holder disposed on a substrate, the image sensor being disposed on the upper surface of the substrate, the holder integrally has a protrusion that protrudes toward the image sensor and an outer peripheral portion provided outside the protrusion, the lower end of the outer peripheral portion being lower than the lower end of the protrusion,
the lower end surface of the protrusion is fixed to the upper surface of the image sensor with an adhesive, and the lower end surface of the outer peripheral portion is fixed to the upper surface of the substrate with an adhesive.

3. The camera module according to claim 1, wherein the holder has a top plate formed integrally therewith just above the image sensor, and the top plate has an opening that functions as an optical stop.

4. The camera module according to claim 1, wherein the outer peripheral surface of the lens is in contact with and fixed by adhesion to the inner peripheral surface of the holder.
